(19) United States
(12) Patent Application Publication
(10) Pub. No.: US 2011/0072481 A1
(43) Pub. Date: Mar. 24, 2011

(54) INTEGRATED RECEIVING DEVICE AND A METHOD FOR PREVENTING THE INTEGRATED RECEIVING DEVICE FROM HAVING INSUFFICIENT MEMORY

(75) Inventor: SHIH-PIN CHEN, Tu-Cheng (TW)

(73) Assignee: HON HAI PRECISION INDUSTRY CO., LTD., Tu-Cheng (TW)

(21) Appl. No.: 12/628,299

(22) Filed: Dec. 1, 2009

(30) Foreign Application Priority Data
Sep. 21, 2009 (CN) 200910307389.3

(51) Int. Cl. H04N 7/173

(52) U.S. Cl. 725/116; 725/132; 725/134

(57) ABSTRACT

An integrated receiving device (IRD) and a method for preventing the IRD from having insufficient memory are provided. The IRD connects to a headend via a CATV network. The IRD acquires attributes of an application from the headend, and analyzes the attributes to obtain a memory-usage descriptor of the application. The IRD determines whether the IRD has sufficient memory to store the application according to the memory-usage descriptor. If the IRD have insufficient memory, a bound application or an unbound application which has a lower priority will be killed till the IRD has sufficient memory to store the application. After the application is downloaded, the downloaded application may be saved in a storage system of the IRD.

### BACKGROUND

1. Technical Field

Embodiments of the present disclosure generally relate to an integrated receiving device, and more particularly to a method for preventing the integrated receiving device from having insufficient memory.

2. Description of Related Art

An open cable application platform (OCAP) is an operating system layer designed for consumer electronics that connect to a cable television. Unlike operating systems on a personal computer, a cable company can control what OCAP applications run on a consumer's machine, such as an integrated receiving device. Designed by CableLabs, OCAP applications are intended for interactive services such as e-commerce, online banking, electronic program guides, and digital video recording. Cable companies have required OCAP as an open platform for developing OCAP applications. The OCAP applications may be downloaded to run on the integrated receiving device. However, before the OCAP applications running, an available memory of the integrated receiving device cannot be predicted, and a downloading time may be long.

What is needed, therefore, is a method to overcome the aforementioned problems.

### BRIEF DESCRIPTION OF THE DRAWINGS

FIG. 1 is a block diagram of one embodiment of an integrated receiving device.

FIG. 2 is a block diagram of function modules of a memory managing unit included in the integrated receiving device of FIG. 1.

FIG. 3 is a schematic diagram indicating exemplary attributes of an application.

FIG. 4 is a schematic diagram indicating an exemplary memory-usage descriptor of the application of FIG. 3.

FIG. 5 is a flowchart illustrating one embodiment of a method for preventing the integrated receiving device of FIG. 1 from having insufficient memory.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

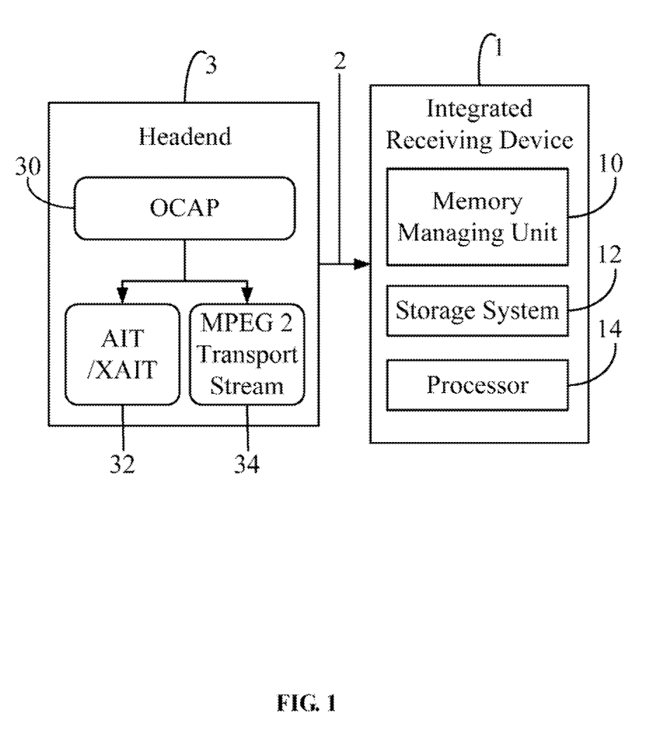

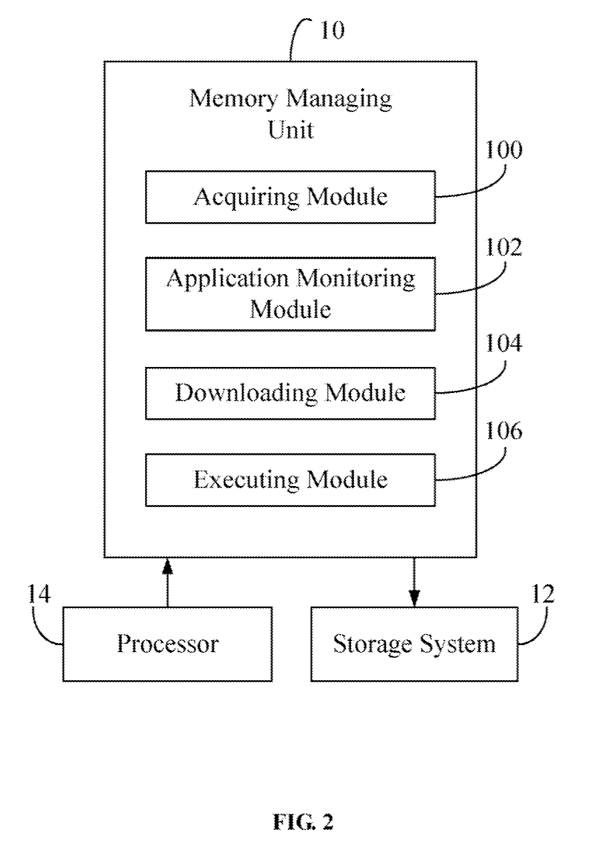

FIG. 1 is a block diagram of one embodiment of an integrated receiving device (IRD) 1. The IRD 1 is connected with a headend 3 via a community antenna television (CATV) network 2. In one embodiment, the IRD 1 includes a memory managing unit 10, a storage system 12, and at least one processor 14. The at least one processor 14 is operable to execute one or more computerized operations of the memory managing unit 10 that may be stored in the storage device 12. The storage device 12 may be a hard disk drive, a compact disc, a digital video disc, or a tape drive. Before the IRD 1 downloads an application from the headend 3, such as a video-on-demand application, a music player application, or a web browsing application, the memory managing unit 10 determines whether the IRD 1 has enough available memory to store the application for execution. When the IRD 1 has insufficient memory to store the application, the memory managing unit 10 may kill one or more applications of the IRD 1 that have lower priorities to release memory space of the IRD 1, so as to prevent the IRD 1 from having insufficient memory to run the application. Some embodiments of methods of preventing the IRD 1 from having the insufficient memory will be described in greater detail in FIG. 2 to FIG. 5.

In one embodiment, the IRD 1 may be a set-top box, and connects with at least one television.

In the embodiment, the headend 3 includes an open cable application platform (OCAP) 30. The OCAP 30 is installed with at least one application. Each of the at least one application can be partitioned into two parts: an application information table/extended application information table (AIT/XAIT) part 12 and a moving picture expert group—2 (MPEG2) transport stream 14. The AIT/XAIT part 12 stores attributes of the at least one application. When the IRD 1 needs to download an application from the OCAP 10 of the headend 3, the attributes of the application is firstly acquired by the IRD 1 via the MPEG2 transport stream 14. The attributes includes a file size of the application, a priority of the application, and a working state of the application, for example. The working state indicates whether the application is a bounded application related to a current executed application or an unbounded application related to the current executed application of the IRD 1. In the embodiment, the bounded application means the application is directly related with a current application to be executed by the IRD 1, and the unbounded application means the application is indirectly related with the current application. For example, if the current application indicates a football match, a scoring software, which relates to the football match, may be indicated as the bounded application.

FIG. 2 is a block diagram of function modules of the memory managing unit 10 included in the IRD 1. The memory managing unit 10 may include a plurality of instructions and executed by the at least one processor 14. In one embodiment, the memory managing unit 10 may include an acquiring module 100, an application monitoring module 102, a downloading module 104, and an executing module 106.

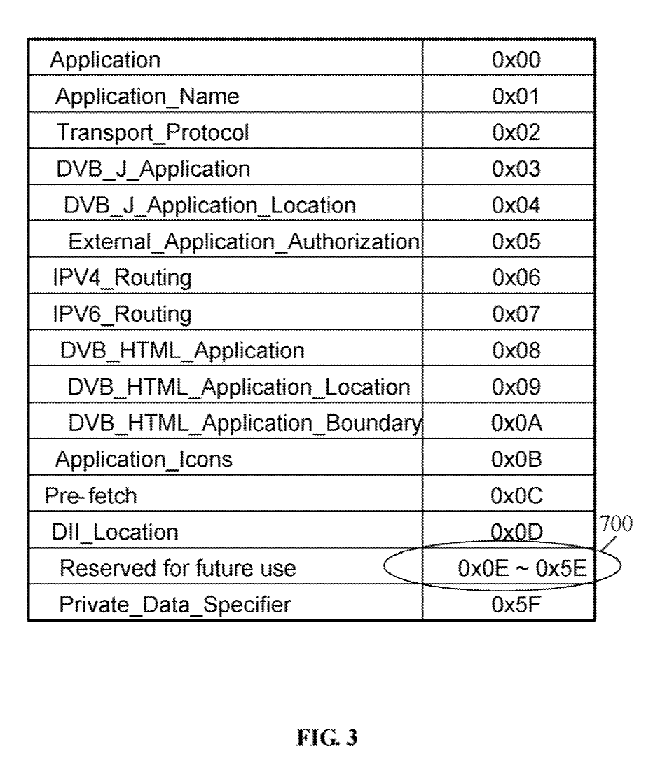

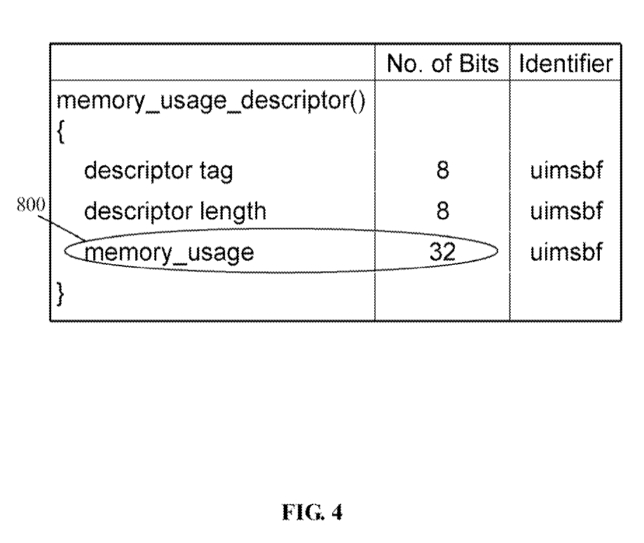

The acquiring module 100 is operable to acquire attributes of an application from the headend 3 via a CATV network 2. The attributes of the application are described in FIG. 3, for example. The acquiring module 100 further analyzes the attributes to obtain a memory-usage descriptor of the application, see in FIG. 4. In one embodiment, FIG. 3 indicates a recording position (marked as “700”) of the memory-usage descriptor in the attributes of the application. Contents of the memory-usage descriptor are recorded in FIG. 4. As shown in FIG. 4, a memory-usage 800 of the application is described.

The application monitoring module 102 is operable to determine whether the IRD 1 has sufficient memory to store the application according to the memory-usage descriptor. If the IRD 1 has insufficient memory to store the application, the application monitoring module 102 kills a bound application which has a lower priority in the IRD1. After the bound application which has a lower priority is killed, the application monitoring module 102 further kills an unbound application which has a lower priority in the IRD 1 if the IRD has insufficient memory to store the application. The method for killing the bounded application and the unbounded application may be repeated till the IRD 1 has sufficient memory to store the application.

When the IRD 1 has sufficient memory to store the application, the downloading module 104 downloads the application from the headend 3, and saves the downloaded application in the storage system 12 of the IRD 1.

The executing module 106 is operable to execute the downloaded application.

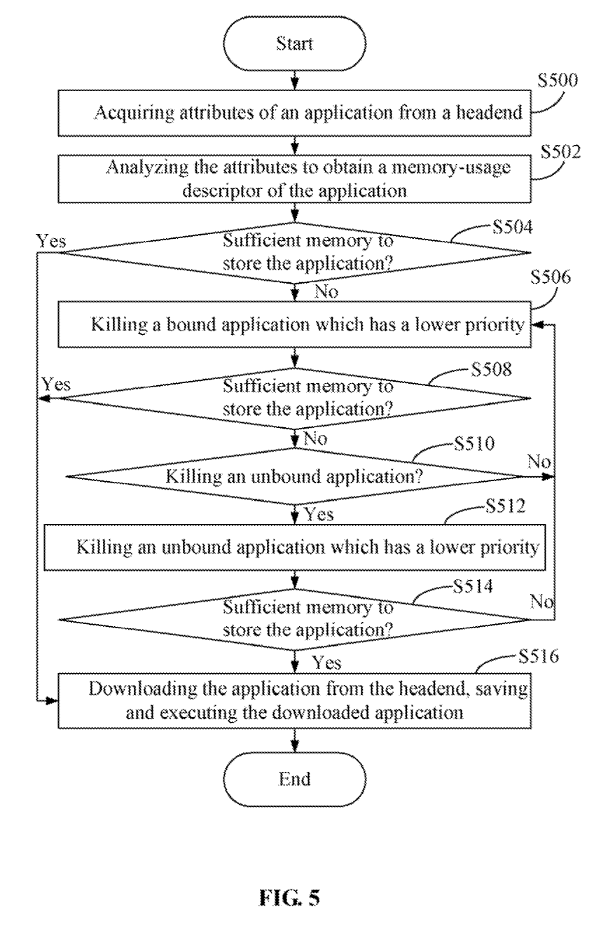

FIG. 5 is a flowchart illustrating one embodiment of a method for preventing the IRD 1 from having insufficient memory. Depending on the embodiment, additional blocks in the flow of FIG. 5 may be added, others removed, and the ordering of the blocks may be changed.

Before the IRD 1 downloads an application from the headend 3, in block S500, the acquiring module 100 acquires attributes of the application from the headend 3.

In block S502, the acquiring module 100 analyzes the attributes to obtain a memory-usage descriptor of the application.

In block S504, the application monitoring module 102 determines whether the IRD 1 has sufficient memory to store the application according to the memory-usage descriptor. If the IRD 1 has sufficient memory to store the application, the flow enters to block S516. If the IRD 1 has insufficient memory to store the application, the flow enters to block S506.

In block S506, the application monitoring module 102 kills a bound application which has a lower priority in the IRD. In the embodiment, the bounded application is directly related with the application to be downloaded by the application monitoring module

In block S508, the application monitoring module 102 determines whether the IRD 1 has sufficient memory to store the application after block S506. If the IRD 1 still has insufficient memory to store the application, the flow enters to block S510. Otherwise, if the IRD 1 has sufficient memory to store the application, the flow enters to block S516.

In block S510, the application monitoring module 102 prompts a box to determine whether an unbound application needs to be killed. If the unbound application needs to be killed, the flow enters to block S512. If the unbound application does not need to be killed, the flow returns to block S506, and then a second bound application whose priority is lowers than the bound application killed in block S506 is killed.

In block S512, the application monitoring module 102 kills the unbound application which has a lower priority in the IRD 1. In the embodiment, the unbounded application is indirectly related with the application to be downloaded by the application monitoring module 102.

In block S514, the application monitoring module 102 determines whether the IRD 1 has sufficient memory to store the application after block S512. If the IRD 1 still has insufficient memory to store the application, the flow returns to block S506. Otherwise, if the IRD 1 has sufficient memory to store the application, the flow enters to block S516.

In block S516, the downloading module 104 downloads the application from the OCAP 30 of the headend 3 and saves the downloaded application in the storage system 12, and then the executing module 106 executes the downloaded application stored in the storage system 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for preventing an integrated receiving device (IRD) from having insufficient memory, the IRD being connected with a headend via a community antenna television (CATV) network, the method comprising:
(a) acquiring attributes of an application from the headend through the CATV network;
(b) analyzing the attributes to obtain a memory-usage descriptor of the application;
(c) determining whether the IRD has sufficient memory to store the application according to the memory-usage descriptor;
(d) killing a bound application which has a lower priority in the IRD, if the IRD has insufficient memory to store the application;
(e) killing an unbound application which has a lower priority in the IRD, if the IRD has insufficient memory to store the application after block (d);
(f) repeating blocks (d) and (e) till the IRD has sufficient memory to store the application; and
(g) downloading the application from the headend, and saving the downloaded application in a storage system of the IRD.

2. The method as described in claim 1, wherein the attributes is stored in an application information table/extended application information table (AIT/XAIT) part of the headend, and is transmitted to the IRD via a moving picture expert group—2 (MPEG2 transport stream.

3. The method as described in claim 1, wherein the memory-usage descriptor records a file size of the application.

4. The method as described in claim 1, further comprising:
executing the downloaded application.

5. An integrated receiving device (IRD), the IRD being connected with a headend via a community antenna television (CATV) network, the IRD comprising:
an acquiring module operable to acquire attributes of an application from the headend through the CATV network, and analyze the attributes to obtain a memory-usage descriptor of the application;
an application monitoring module operable to determine whether the IRD has sufficient memory to store the application according to the memory-usage descriptor, and kill a bound application or an unbound application which has a lower priority in the IRD if the IRD has insufficient memory to store the application;
a downloading module operable to download the application from the headend and save the downloaded application in a storage system of the IRD if the IRD has sufficient memory to store the application; and
at least one processor that executes the acquiring module, the application monitoring module, and the downloading module.

6. The IRD as described in claim 5, further comprising:
an executing module operable to store the downloaded application.

7. The IRD as described in claim 5, wherein the attributes is stored in an application information table/extended application information table (AIT/XAIT) part of the headend, and is transmitted to the IRD via a moving picture expert group—2 (MPEG2 transport stream.

8. The IRD as described in claim 5, wherein the memory-usage descriptor records a file size of the application.

9. A storage medium having stored thereon instructions that, when executed by a processor of an integrated receiving device (IRD), causes the processor to prevent the IRD from having insufficient memory, the IRD being connected with a headend via a community antenna television (CATV) network, the method comprising:
(a) acquiring attributes of an application from the headend through the CATV network;
(b) analyzing the attributes to obtain a memory-usage descriptor of the application;
(c) determining whether the IRD has sufficient memory to store the application according to the memory-usage descriptor;
(d) killing a bound application which has a lower priority in the IRD, if the IRD has insufficient memory to store the application;
(e) killing an unbound application which has a lower priority in the IRD, if the IRD has insufficient memory to store the application after block (d);
(f) repeating blocks (d) and (e) till the IRD has sufficient memory to store the application; and
(g) downloading the application from the headend, and saving the downloaded application in a storage system of the IRD.

10. The storage medium as described in claim 9, wherein the attributes is stored in an application information table/extended application information table (AIT/XAIT) part of the headend, and is transmitted to the IRD via a moving picture expert group—2 (MPEG2 transport stream.

11. The storage medium as described in claim 9, wherein the memory-usage descriptor records a file size of the application.

12. The storage medium as described in claim 9, wherein the method further comprises:
executing the downloaded application.
